(19) United States
(12) Patent Application Publication
(10) Pub. No.: US 2019/0379982 A1
(43) Pub. Date: Dec. 12, 2019

(54) RESONANT LOUDSPEAKER FOR PREVENTING DROPPING

(71) Applicant: Innovation Sound Technology Co., Ltd., Shenzhen (CN)

(72) Inventors: Shun Ming Yuen, Shenzhen (CN); An Shuang Ming, Shenzhen (CN); Hai Xun Chen, Shenzhen (CN)

(21) Appl. No.: 16/527,016

(22) Filed: Jul. 31, 2019

Related U.S. Application Data
(63) Continuation-in-part of application No. PCT/CN2018/102317, filed on Aug. 24, 2018.

(30) Foreign Application Priority Data
Jun. 11, 2018 (CN) 201820894289.X

(51) Int. Cl. H04R 9/06; H04R 7/18; H04R 7/12; H04R 9/04

(52) U.S. Cl. CPC H04R 9/06; H04R 9/045; H04R 7/127; H04R 7/18

(57) ABSTRACT

The present invention discloses a resonant loudspeaker for preventing dropping, comprising: a plastic bracket, wherein the bottom of the plastic bracket is provided with a clamping groove; a base, wherein the periphery of the base is clamped into the clamping groove; a voice coil arranged on an upper part of the base, wherein the top of the voice coil is connected with a coil; and a U cup, wherein the bottom of the U cup is connected with the coil, the upper part of the plastic bracket is bonded with an upper bouncing wave and one end of the upper bouncing wave is bonded with the U cup. The present invention adds the plastic bracket, a lower bouncing wave and the upper bouncing wave, so as to reduce distortion, realize smooth frequency response curve and effectively solve the problems of dropping, life and high distortion of a vibrating loudspeaker.

### CROSS REFERENCE TO RELATED APPLICATIONS

The present application is a Continuation-In-Part Application of PCT Application No. PCT/CN2018/102317 filed on Aug. 24, 2018, which claims the benefit of Chinese Patent Application No. 201820894289.X filed on Jun. 11, 2018. All the above are hereby incorporated by reference.

### TECHNICAL FIELD

The present invention specifically relates to a resonant loudspeaker for preventing dropping, and belongs to the technical field of loudspeakers.

### BACKGROUND

A resonant loudspeaker means a speaker that has no loudspeaker but can play melodious music like other speakers. The resonant loudspeaker is the recently innovated product and is now very popular on the market. The emergence of the resonant speaker is intended to break through the limitations of the traditional ordinary audio effects. Since the sound of the ordinary speaker is transmitted through the horizontal oscillating air of the loudspeaker to achieve the sound effect, there is certain limited directivity. This is not the case with the resonant speaker, which can be transmitted at 360° frequency. At present, a vibration type loudspeaker is fixed by screws, which is high in cost, long in manufacturing cycle, poor in dropping effect and large in distortion of a frequency response curve.

### SUMMARY

To solve the technical problems to overcome the existing defects, the present invention provides a resonant loudspeaker for preventing dropping. The present invention adds a plastic bracket, a lower bouncing wave and an upper bouncing wave, so as to reduce distortion, realize smooth frequency response curve and effectively solve the problems of dropping and life of a vibrating loudspeaker, thereby effectively solving the problems in the background.

To solve the above technical problems, the present invention provides the following technical solution:

The present invention provides a resonant loudspeaker for preventing dropping, comprising:
a plastic bracket, wherein the bottom of the plastic bracket is provided with a clamping groove;
a base, wherein the periphery of the base is clamped into the clamping groove;
a voice coil arranged on an upper part of the base, wherein the top of the voice coil is connected with a coil; and
a U cup, wherein the bottom of the U cup is connected with the coil, the upper part of the plastic bracket is bonded with an upper bouncing wave and one end of the upper bouncing wave is bonded with the U cup;
a lower bouncing wave (3), the lower bouncing wave is arranged on one side of the voice coil (2).

As a preferred technical solution of the present invention, the resonant loudspeaker also comprises a binding post; one end of the binding post is connected with the coil; and the other end is connected with alternating current.

The present invention achieves the beneficial effects: a resonant loudspeaker for preventing dropping adds the plastic bracket, a lower bouncing wave and the upper bouncing wave, so as to reduce distortion, realize smooth frequency response curve and effectively solve the problems of dropping and life of a vibrating loudspeaker. When the loudspeaker is under a finished product drop test, the voice coil is separated from an iron shell, thereby damaging the loudspeaker. When a bracket protecting product drops, the displacement of the iron shell is restricted, so that the iron shell is not separated from the voice coil. The added upper bouncing wave is intended to improve the unbalanced vibration generated when the loudspeaker is in operation. The upper bouncing wave and the lower bouncing wave support the voice coil jointly to perform standard piston motion in a magnetic circuit, avoiding tilting and reducing distortion. If only the lower bouncing wave is used, balanced vibration of the voice coil may not be ensured.

### DESCRIPTION OF DRAWINGS

The drawings are used to provide further understanding for the present invention and constitute part of the description. The drawings are used to explain the present invention together with the embodiments of the present invention, and do not constitute a limitation to the present invention.

In the figures:

FIG. 1 is an external structural schematic diagram of a resonant loudspeaker for preventing dropping in an embodiment of the present invention.

FIG. 2 is a sectional view of a resonant loudspeaker for preventing dropping in an embodiment of the present invention.

Numerals in the figures: 1 base; 2 voice coil; 3 lower bouncing wave; 4 plastic bracket; 5 upper bouncing wave; 6 U cup; 7 coil; 8 clamping groove; and 9 binding post.

### DETAILED DESCRIPTION

The preferred embodiment of the present invention will be described below in combination with the drawings. It should be understood that the preferred embodiment described herein is only used for describing and explaining the present invention, but is not used for limiting the present invention.

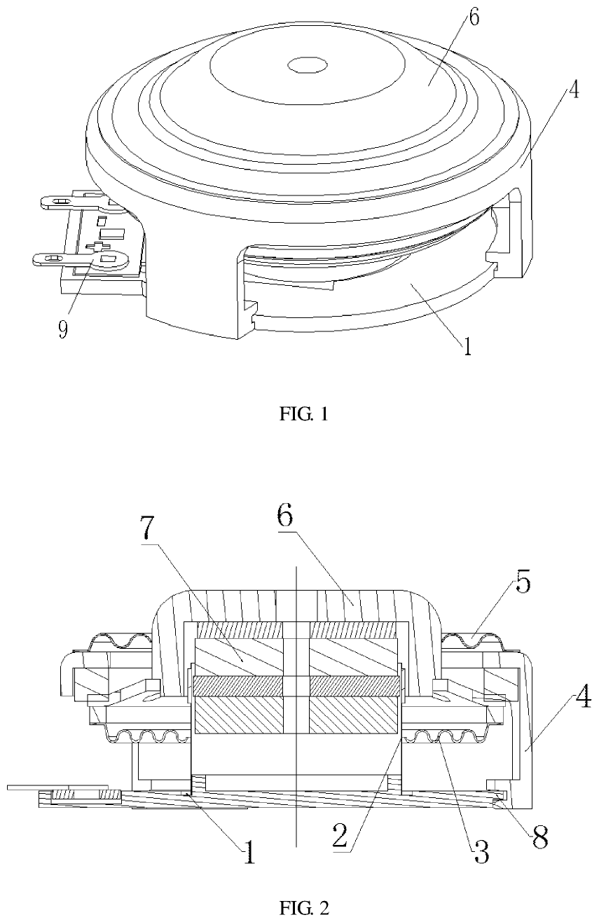

Embodiment: with reference to FIGS. 1-2, the present invention provides a resonant loudspeaker for preventing dropping, comprising:
a plastic bracket 4, wherein the bottom of the plastic bracket 4 is provided with a clamping groove 8;
a base 1, wherein the periphery of the base 1 is clamped into the clamping groove 8, which is convenient for disassembly and use;
a voice coil 2 arranged on an upper part of the base 1, wherein the top of the voice coil 2 is connected with a coil 7; and
a U cup 6, wherein the bottom of the U cup 6 is connected with the coil 7, the upper part of the plastic bracket 4 is bonded with an upper bouncing wave 5 and one end of the upper bouncing wave 5 is bonded with the U cup 6;
a lower bouncing wave 3, the lower bouncing wave is arranged on one side of the voice coil 2. The lower bouncing wave 3 is generally made of synthetic fiber material to ensure that the acoustic performance of the finished product after falling or vibrating also meets the distortion required by the customer (or design). Within the frequency response curve specification, it breaks through the bottleneck of the fixed design of similar loudspeakers in the market and maintains its superior performance.

Further, the resonant loudspeaker also comprises a binding post 9; one end of the binding post 9 is connected with the coil 7; and the other end is connected with alternating current.

Further, the top of the plastic bracket 4 is bonded with the U cup 6.

It should be indicated that, the present invention is a resonant loudspeaker for preventing dropping. When working, according to the left-hand rule, when input alternating current passes through the coil of the vibrating loudspeaker, the coil cuts magnetic lines (a constant magnetic field formed by the main magnetics and secondary magnetics of the loudspeaker, and a washer U cup). The coil of the voice coil will produce motion under the action of force, and the direction and magnitude of motion will vary according to the direction and magnitude of the input signal. The up and down motion of a tube of the voice coil drives a panel and a wood board to vibrate, and also drives a bonded speaker object such as sponge to vibrate to compress and stretch the proximate air to propagate sound waves. The loudspeaker will sound in front and behind. Firstly, the sound is transmitted by solid vibrating bones in contact with the human head and the human body; and secondly, the sound is propagated to the human ear through a gas medium. By adding the plastic bracket, the lower bouncing wave and the upper bouncing wave, the present invention can reduce distortion, realize smooth frequency response curve and effectively solve the problems of dropping and life of a vibrating loudspeaker. The present invention adds the plastic bracket, the lower bouncing wave and the upper bouncing wave, so as to reduce distortion, realize smooth frequency response curve and effectively solve the problems of dropping and life of the vibrating loudspeaker. When the loudspeaker is under a finished product drop test, the voice coil is separated from an iron shell, thereby damaging the loudspeaker. When a bracket protecting product drops, the displacement of the iron shell is restricted, so that the iron shell is not separated from the voice coil. The added upper bouncing wave is intended to improve the unbalanced vibration generated when the loudspeaker is in operation. The upper bouncing wave and the lower bouncing wave support the voice coil jointly to perform standard piston motion in a magnetic circuit, avoiding tilting and reducing distortion. If only the lower bouncing wave is used, balanced vibration of the voice coil may not be ensured.

Finally, it should be noted that the above description is only a preferred embodiment of the present invention, and is not intended to limit the present invention. Although the present invention is described in detail with reference to the above embodiment, those skilled in the art may still modify the technical solution recorded in the above embodiment, or equivalently replace some of the technical features. Any modification, equivalent replacement, improvement, etc. made within the spirit and the principle of the present invention shall be included within the protection scope of the present invention.

What is claimed is:

1. A resonant loudspeaker for preventing dropping, characterized by comprising:
a plastic bracket (4), wherein the bottom of the plastic bracket (4) is provided with a clamping groove (8);
a base (1), wherein the periphery of the base (1) is clamped into the clamping groove (8);
a voice coil (2) arranged on an upper part of the base (1), wherein the top of the voice coil (2) is connected with a coil (7); and
a U cup (6), wherein the bottom of the U cup (6) is connected with the coil (7), the upper part of the plastic bracket (4) is bonded with an upper bouncing wave (5) and one end of the upper bouncing wave (5) is bonded with the U cup (6);
a lower bouncing wave (3), the lower bouncing wave is arranged on one side of the voice coil (2).

2. The resonant loudspeaker for preventing dropping according to claim 1, characterized in that the resonant loudspeaker also comprises a binding post (9); one end of the binding post (9) is connected with the coil (7); and the other end is connected with alternating current.
